(19) United States
(12) Patent Application Publication
(10) Pub. No.: US 2026/0084663 A1
(43) Pub. Date: Mar. 26, 2026

(54) CROSS-TRUSS WITH LEVELING JACK SUPPORT

(71) Applicant: Thor Tech, Inc., Elkhart, IN (US)

(72) Inventors: Dustin Feller, Wolcottville, IN (US); Thomas Ramsay, Elkhart, IN (US)

(73) Assignee: Thor Tech, Inc., Elkhart, IN (US)

(21) Appl. No.: 19/334,447

(22) Filed: Sep. 19, 2025

Related U.S. Application Data
(60) Provisional application No. 63/697,030, filed on Sep. 20, 2024.

(51) Int. Cl. B60S 9/22; B60S 9/10

(52) U.S. Cl. CPC B60S 9/22; B60S 9/10; B60Y 2200/14

(57) ABSTRACT

A cross-truss assembly, cross-truss, and method for installing the same on a vehicle chassis, such as that of an RV, is disclosed. The cross-truss assembly includes the vehicle chassis, the vehicle chassis having a plurality of frame rails that extend along a longitudinal direction of the vehicle chassis and that are configured to mount a vehicle body and a plurality of lateral members that join the plurality of frame rails together. The cross-truss is similarly arranged transverse to the plurality of frame rails and is fastened thereto. The cross-truss includes extension portions at each end that extend beyond the frame rails, and a leveling jack is mounted to each of the extension portions. The cross-truss is mounted to the vehicle frame by removing at least two outriggers from the vehicle frame and mounting the cross-truss to the vehicle frame in their place.

### CROSS-REFERENCE TO RELATED APPLICATIONS

This application claims benefit to U.S. Provisional Application Ser. No. 63/697,030 filed Sep. 20, 2024.

### TECHNICAL FIELD

The present disclosure relates, generally, to leveling systems for vehicles and, more particularly, to leveling systems for recreational vehicles (RVs), components and structures thereof, and methods for using and/or installing the same.

### BACKGROUND

RVs benefit from proper leveling when parked to assist with the correct operation of onboard systems, to enhance occupant comfort, and to maintain the structural integrity of the RV structure or operating components thereof (e.g., by reducing wear on systems like slide-out mechanisms). Conventional RV leveling methods typically involve the manual placement of leveling blocks under wheels or the deployment of jacks at various locations along the vehicle chassis. An operator must then adjust these elements, reposition the vehicle, and so on until the RV is properly leveled and stable. These methods suffer from limitations including excessive setup time, inadequate ground clearance, poor adaptation to uneven or soft terrain conditions, complex or arduous calibration requirements, risk of operator injury (e.g., from handling heavy blocks and/or manipulating jack stands), and/or the inability to compensate for vehicle weight distribution and/or changes thereof during use.

### SUMMARY

In one aspect, a cross-truss assembly for at least partially supporting a vehicle chassis, the assembly including the vehicle chassis. The vehicle chassis has a plurality of frame rails extending in a longitudinal direction of the chassis and that are configured to mount a vehicle body and a plurality of lateral members joining the frame rails together. The cross-truss is arranged transverse to the plurality of frame rails and is fastened to at least two of the frame rails. The cross-truss has an extension portion at either end that extends beyond the frame rails, such that a leveling jack is mounted to each of the extension portions.

In another aspect, a method for installing a cross-truss, the method including providing a vehicle chassis. The vehicle chassis has a plurality of frame rails extending in a longitudinal direction of the chassis and that are configured to mount a vehicle body, a plurality of lateral members joining the frame rails together, and at least two outriggers, each mounted to a respective one of the plurality of frame rails. The method further includes removing the at least two outriggers and securing the cross-truss to the vehicle chassis.

In another aspect, a cross-truss for mounting to a vehicle chassis, the cross-truss including a main beam extending in a transverse direction and that has an extension portion at each end. The cross-truss further has a leveling jack mounted to each of the extension portions and a plurality of mounting plates for mounting the cross-truss to the vehicle chassis, such that the plurality of mounting plates each have a plurality of through-holes that are arranged in a predetermined pattern that matches an outrigger pattern used for securing the outriggers to the vehicle chassis.

These and additional features provided by the aspects described herein will be more fully understood in view of the following detailed description, in conjunction with the drawings.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 schematically depicts an illustrative vehicle chassis as described and illustrated herein;

FIG. 2 schematically depicts an illustrative cross-truss system for supporting an RV or other vehicle as described and illustrated herein;

FIG. 3A schematically depicts a perspective view of an illustrative cross-truss as described and illustrated herein;

FIG. 3B schematically depicts a perspective view of an illustrative cross-truss as described and illustrated herein;

FIG. 4 schematically depicts a further leveling jack as described and illustrated herein;

FIG. 5 schematically depicts an illustrative cross-truss system for supporting an RV or other vehicle as described and illustrated herein;

FIG. 6A schematically depicts a perspective view of an illustrative cross-truss as described and illustrated herein;

FIG. 6B schematically depicts a perspective view of an illustrative cross-truss as described and illustrated herein;

FIG. 6C schematically depicts a perspective view of an illustrative cross-truss as described and illustrated herein;

FIG. 7 schematically depicts a further leveling jack as described and illustrated herein; and

FIG. 8 depicts an illustrative method for installing a cross-truss as described and illustrated herein.

### DETAILED DESCRIPTION

Aspects described herein pertain to a cross-truss assembly, cross-truss, and method for installing the same on a vehicle, such as an RV. The cross-truss may be mounted to the vehicle chassis in place of a pair of outriggers, which are normally provided for securing a vehicle body to a vehicle chassis. By taking advantage of existing mounting infrastructure (e.g., the pattern of through-holes already provided in the vehicle chassis for mounting the outriggers), the cross-truss may be more easily and reliably secured to the vehicle frame and in a manner that allows for the cross-truss to support the weight of at least that end of the vehicle or RV, such as to assist in leveling the vehicle across a wider variety of use cases.

By mounting the leveling jacks in this way, the cross-truss allows the spread of the leveling jacks to be increased beyond the width of the frame rails, resulting in a more stable leveling of the vehicle. The cross-truss may further be installed without interference from other components provided in and/or on the chassis, such as coolant systems, fuel tanks, batteries, and/or the like. The configuration also results in more efficient manufacturing processes, as the use of existing hardware and/or hole patterns means that new holes and/or other modifications to the vehicle frame may be avoided or mitigated when installing a cross-truss in a new vehicle or when retrofitting an existing vehicle with a cross-truss.

As used herein, “top,” “bottom”, “up,” and “down” refer to directions relative to gravity and a corresponding height direction of the RV and/or chassis.

As used herein, “spread” refers to the horizontal and/or transverse distance between contact points of deployed stabilizing elements, such as those leveling jacks and/or further leveling jacks as discussed herein. Spread may be used interchangeably with outrigger spread, jack spread, stabilizer spread, footprint, and/or the like except where explicitly indicated otherwise.

As used herein, “vehicle” refers to any self-propelled or towable wheeled conveyance designed for ground transportation, including passenger automobiles, trucks, vans, busses, RVs, travel trailers, fifth-wheel trailers, motorhomes, commercial trailers, construction equipment, agricultural equipment, mobile machinery, and/or the like, without limit.

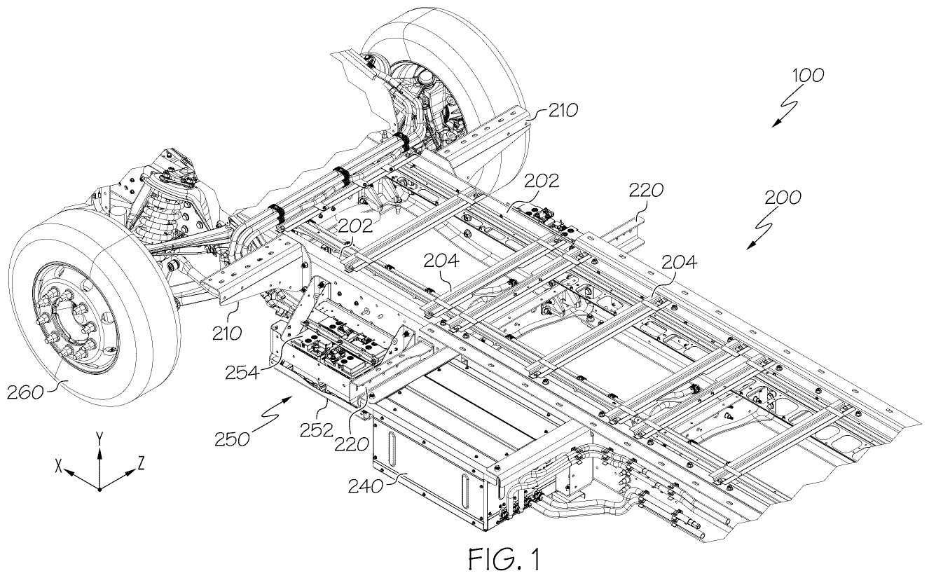

An RV may have an RV body with a roof and walls that enclose a living space in which passengers may travel and/or reside. The body of the RV may be supported by a frame or a vehicle chassis, such as those described in FIGS. 1-2 and 5.

Turning now to FIG. 1, an illustrative vehicle chassis 200 is shown. The vehicle chassis 200 may have a plurality of frame rails 202 that extend along a longitudinal direction of the vehicle chassis 200. The frame rails 202 are joined together by a plurality of lateral members 204 that extend in the transverse direction to join the frame rails together. As shown in FIG. 1 and throughout the Drawings, the longitudinal direction is the X direction, which sits substantially in line with the forward and/or rearward travel direction of the vehicle 100. Substantially orthogonal to the longitudinal direction is a transverse direction, or Z-direction as shown. Substantially orthogonal to both the longitudinal and transverse directions is a vertical direction, or Y-direction as shown.

The vehicle chassis 200 in FIG. 1 is shown prior to installation of a cross-truss consistent with those disclosures herein. The vehicle chassis 200 includes a plurality of outriggers 210, 220 to which various elements of the vehicle body (not shown) may be attached. Each of the outriggers 210, 220 are secured to the frame rails 202 via a plurality of fasteners arranged in an outrigger pattern. The vehicle chassis 200 may further include any number and/or combination of battery packs or fuel tanks, coolant systems 240, battery racks 250, battery supports 252, batteries and/or auxiliary batteries 254, wheels 260, and/or the like, without limit.

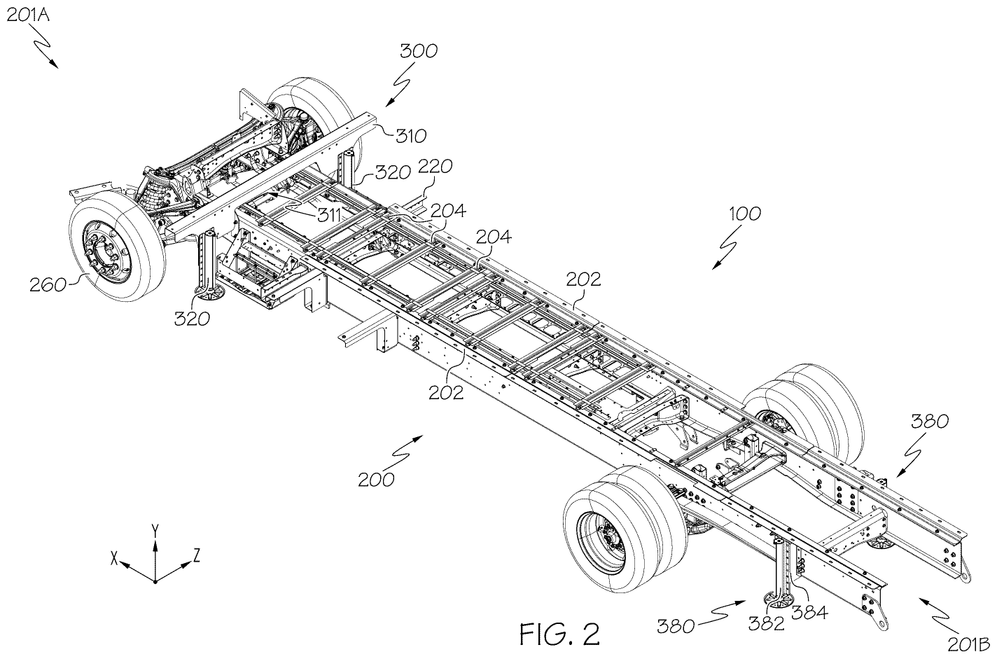

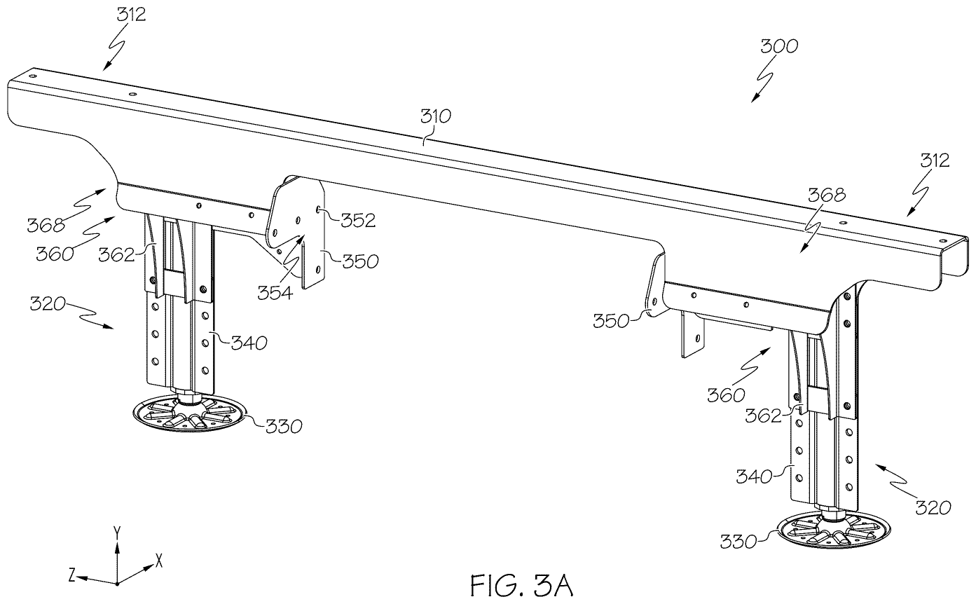

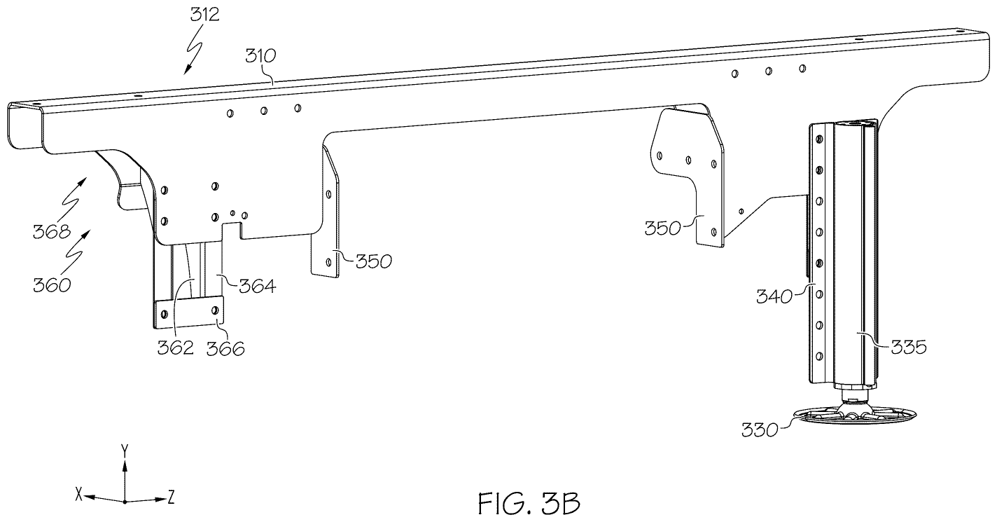

Turning now to FIGS. 2 and 3A-3B, with continued reference to FIG. 1, aspects of a cross-truss 300 are shown. The cross-truss 300 has a main beam 310 to which are mounted a plurality of leveling jacks 320. The cross-truss 300 is shown arranged near a first end 201A of the vehicle chassis 200 and mounted to the frame rails 202 of the vehicle chassis 200. Here, the first set of outriggers 210 (as seen in FIG. 1) have been removed and the cross-truss 300 has been mounted in their stead, while a second set of outriggers 220 yet remain attached to the vehicle chassis 200.

In some aspects, the cross-truss 300 may be mounted to the vehicle chassis 200 such that the main beam 310 is arranged above one or more frame rails 202 and/or such that the cross-truss sits at least partially above the vehicle chassis 200. In some aspects, the cross-truss 300 may be mounted to the vehicle chassis 200 such that the main beam 310 is arranged below one or more frame rails 202 and/or such that the cross-truss sits at least partially below the vehicle chassis 200. In either arrangement, a gap 311 may be present between the main beam 310 and one or more frame rails 202 to assist with the routing of components (e.g., coolant lines, power lines, and/or the like, without limit) through the vehicle chassis 200.

The main beam 310 of the cross-truss 300 may have extension portions 312 at either end that extend, in the transverse direction, beyond the frame rails 202 when the cross-truss 300 is mounted to the vehicle chassis 200. The leveling jacks 320 are correspondingly mounted to these extension portions 312 so that the spread, width, and/or distance between the leveling jacks 320 is greater than a width of the vehicle chassis 200, greater than a spread and/or width between frame rails 202, and/or greater than a spread and/or width between leveling jacks if the leveling jacks were mounted directly to an outside of the vehicle chassis 200 or frame rails. Each leveling jack 320 may include a foot 330 for contacting a ground surface (e.g., grass, dirt, pavement, and/or the like, without limit) and a mounting plate 340 for mounting the leveling jack 320 to the cross-truss 300. Leveling jacks 320 may be driven by one or more actuators 335 that may include any number and/or combination of hydraulic jacks, electric motor jacks, scissor jacks, telescoping jacks, pneumatic jacks, and/or the like, without limit. In some aspects, the leveling jacks 320 may be controlled from a cockpit of the vehicle 100 and/or other location remote to the leveling jacks 320 so that a user and/or operator of the vehicle 100 may deploy and/or configure the leveling jacks 320 without having to get beneath the vehicle 100.

The leveling jacks 320 may be secured to the main beam 310 of the cross-truss via mounting hardware 360. Mounting hardware 360 may include an assembly of vertical plates 364 and horizontal plates 366 provided with mounting holes for securing to the mounting plate 340 of the leveling jack 320. Mounting hardware 360 may be strengthened (e.g., in the longitudinal direction) via at least one web 362. In such an arrangement, the mounting plate 340 sits substantially parallel to the main beam 310 and/or to the transverse direction of the vehicle 100. Main beam 310 may further include one or more flanged portions 368 for providing additional attachment points for the one or more webs 362. By way of the mounting plates of mounting hardware 360, the leveling jacks 320 may be mounted to the main beam 310 such that the mounting plate 340 of the leveling jack 320 is substantially parallel to the transverse direction of the vehicle 100.

In some aspects, extension portions 312 may be provided with a plurality of connecting points (not shown) so that the spread between the leveling jacks 320 may be adjustable, such as for clearance purposes (e.g., to avoid collision with other frame components) and/or to account for the balance and/or stability needs of different models of vehicles. It may be appreciated that, though the mounting hardware 360 of FIGS. 3A-3B are primarily depicted as through-holes for bolt-like fasteners, any comparable fastening means (e.g., welding, crimping, bolting, brackets, riveting, and/or the like, without limit) may be used to secure the leveling jack 320 and/or mounting plate 340 to the main beam 310.

In some aspects, the leveling jacks 320 are controlled manually (e.g., via jog buttons, control panels, switches and/or levers, touchscreen controls, and/or the like, without limit). In some aspects, the leveling jacks 320 may be controlled automatically (e.g., via a controller having a processor, memory, storage, and corresponding software and/or other instructions stored thereon). Automatic control of the leveling jacks 320 may occur in isolated events (e.g., commanded by a user when the vehicle is parked, commanded by a user if it is noticed that the vehicle has settled or shifted), and/or automatic control of the leveling jacks 320 may be ongoing (e.g., the controller is provided with and/or connected to sensors that continuously and/or periodically monitor the state and/or level of the vehicle to make adjustments to bring the vehicle into a level state within predefined thresholds).

The cross-truss 300 may further include a set of mounting plates 350 secured to the main beam 310, such that the mounting plates 350 are used to mount the cross-truss 300 to the frame rails 202 of the vehicle chassis 200. The mounting plates 350 may each be provided with a plurality of through-holes 352 that are arranged in a predetermined hole pattern 354. In some aspects, the predetermined hole pattern 354 matches that of the outrigger 210, such that the through holes 352 of the mounting plates 350 would line up with corresponding holes provided in the frame rails 202 for mounting the outrigger 210. In other words, the predetermined hole pattern 354 matches and/or is compatible with a pattern in which fasteners are arranged to mount the outrigger 210 to the frame rail 202 so that the cross-truss may be similarly mounted to the vehicle chassis 200 via fasteners (e.g., screws, bolts, and/or the like, without limit).

In some aspects, the predetermined hole pattern 354 precisely matches the outrigger pattern and/or matches the outrigger pattern within a predetermined tolerance. In some aspects, the hole pattern 354 only partially matches the outrigger pattern or approximates the outrigger pattern. In some aspects, one or more holes of the predetermined hole pattern may be elongated or oblong, such as to account for manufacturing tolerances, thermal expansion, different outrigger patterns (e.g., from different manufacturers, across different chassis models, and/or across different chassis revisions). In some aspects, the number of holes of the predetermined hole pattern 354 differs from the number of holes of the outrigger pattern. In some aspects, the mounting plates 350 may be permanently attached (e.g., via welding and/or the like, without limit) to the frame rails 202, instead of and/or in addition to the use of fasteners.

It is further contemplated that the mounting plates 350 may be oriented so as to connect to an outer face of the frame rails (as depicted) and/or to connect to any other face (e.g., top, bottom, inside), of the frame rails 202, and/or in any combination, as installation space and/or clearance needs dictate.

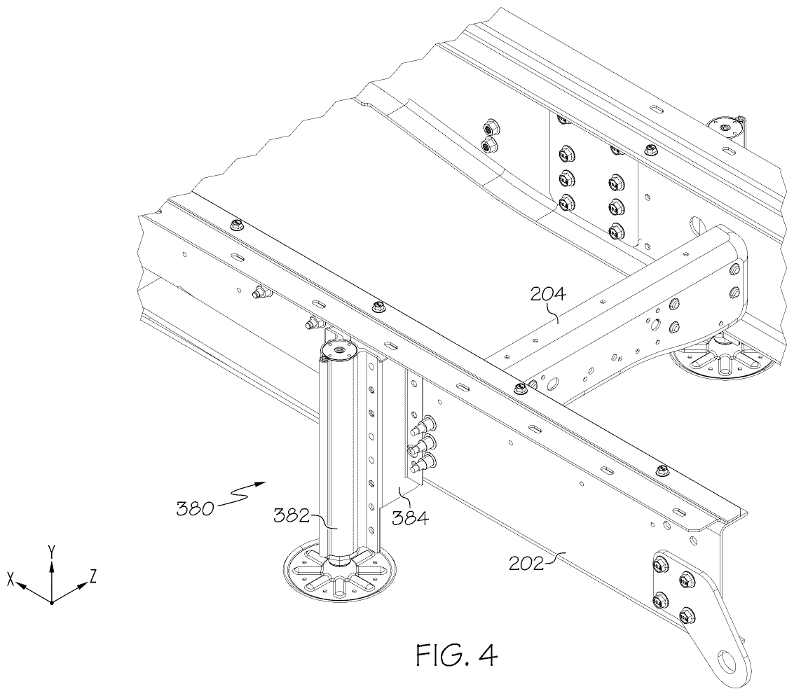

Turning now to FIG. 4, with continued reference to FIGS. 1-3B, a plurality of further leveling jacks 380 are shown arranged near a second end 201B of the vehicle chassis 200 and mounted to the frame rails 202 of the vehicle chassis 200 via. In some aspects, the actuator(s) 382 of the further leveling jacks 380 may be mounted to the frame rails 202 via a mounting bracket 384 (e.g., a C-channel or hat-channel bracket) so as to provide better access to mounting hardware for installation and/or removal.

It may be appreciated that the first end 201A and second end 201B are interchangeable and not to be construed as limiting. The cross-truss 300 may be provided at the front of the vehicle 100 (e.g., near the first end 201A), at the rear end of the vehicle 100 (e.g., near the second end 201B), and/or at both the front and rear ends of the vehicle 100. Any number and/or combination of the wheels 260 and corresponding suspension system, cross-truss 300 and leveling jacks 320, and/or further leveling jacks 380 may be used to stabilize and level the vehicle 100 when the vehicle 100 is parked.

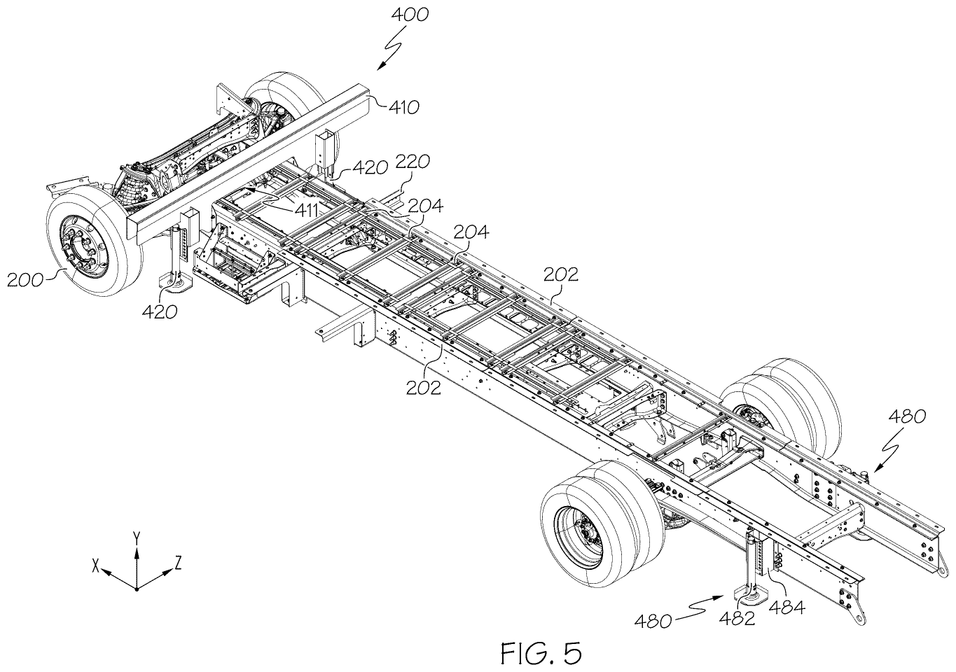

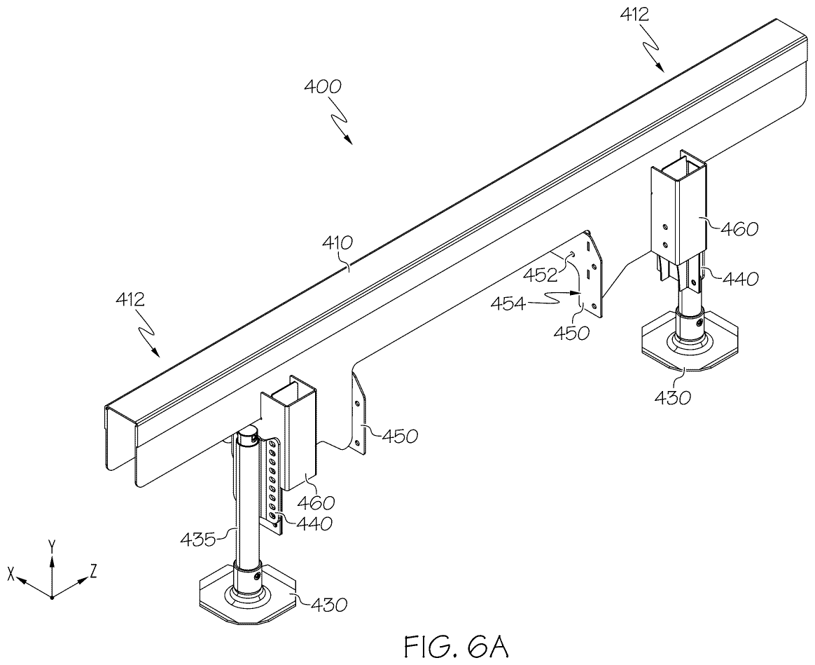

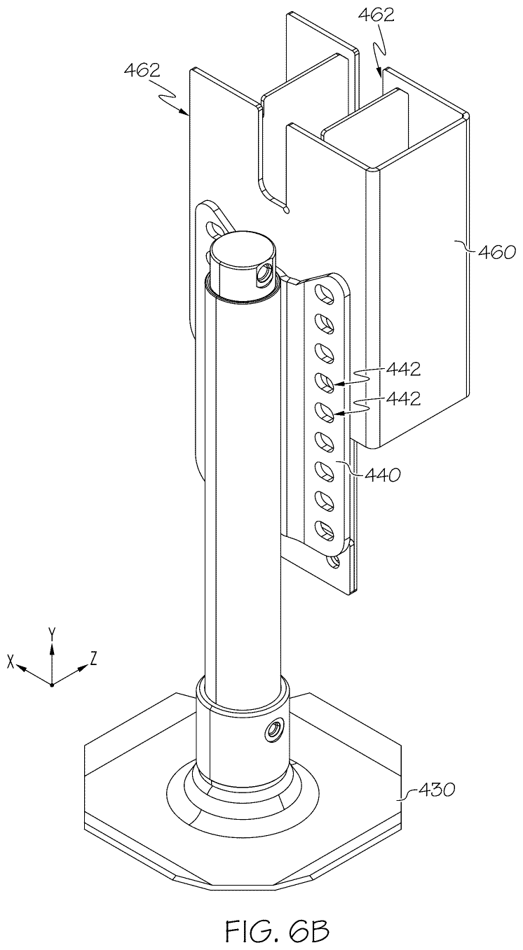

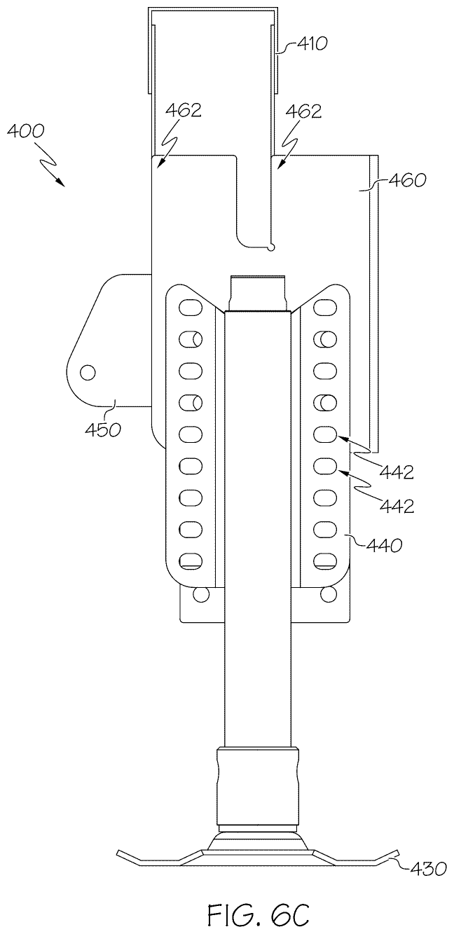

Turning now to FIGS. 5 and 6A-6C, with continued reference to FIG. 1, aspects of a cross-truss 400 are shown. The cross-truss 400 has a main beam 410 to which are mounted a plurality of leveling jacks 420. The cross-truss 400 is shown arranged near a first end 201 of the vehicle chassis 200 and mounted to the frame rails 202 of the vehicle chassis 200. Here, the first set of outriggers 210 (as seen in FIG. 1) have been removed and the cross-truss 400 has been mounted in their stead, while a second set of outriggers 220 yet remain attached to the vehicle chassis 200.

In some aspects, the cross-truss 400 may be mounted to the vehicle chassis 200 such that the main beam 410 is arranged above one or more frame rails 202 and/or such that the cross-truss sits at least partially above the vehicle chassis 200. In some aspects, the cross-truss 400 may be mounted to the vehicle chassis 200 such that the main beam 410 is arranged below one or more frame rails 202 and/or such that the cross-truss sits at least partially below the vehicle chassis 200. In either arrangement, a gap 411 may optionally be present between the main beam 410 and one or more frame rails 202 to assist with the routing of components (e.g., coolant lines, power lines, and/or the like, without limit) through the vehicle chassis 200.

The main beam 410 of the cross-truss 400 may have extension portions 412 at either end that extend, in the transverse direction, beyond the frame rails 202 when the cross-truss 400 is mounted to the vehicle chassis 200. The leveling jacks 420 are correspondingly mounted to these extension portions 412 so that the spread, width, and/or distance between the leveling jacks 420 is greater than a width of the vehicle chassis 200, greater than a spread and/or width between frame rails 202, and/or greater than a spread and/or width between leveling jacks if the leveling jacks were mounted directly to an outside of the vehicle chassis 200 or frame rails 202. Each leveling jack 420 may include a foot 430 for contacting a ground surface (e.g., grass, dirt, pavement, and/or the like, without limit) and a mounting plate 440 with a plurality of through-holes 442 for mounting the leveling jack 420 to the cross-truss 400. Leveling jacks 420 may be driven by one or more actuators 435 that, as above, may include any number and/or combination of hydraulic jacks, electric motor jacks, scissor jacks, telescoping jacks, pneumatic jacks, and/or the like, without limit. Also further to the above, the leveling jacks 420 may be controlled from a cockpit of the vehicle 100 and/or other location remote to the leveling jacks 420 so that a user and/or operator of the vehicle 100 may deploy and/or configure the leveling jacks 420 without having to get beneath the vehicle 100.

The leveling jacks 420 may be secured to the main beam 410 of the cross-truss via mounting hardware 460. Mounting hardware 460 may include an assembly of box sections having grooves or receiving portions 462 for interfacing and/or attachment with the main beam 410 of the cross-truss 400 (e.g., via welding). As seen in FIG. 6C, the main beam 410 has a hollow cross section and is formed as or substantially as a C-channel. In this way, each leg of the C-channel provides an attachment point for the receiving portions 462 so as to increase the available surface area for welding, gluing, and/or the like, without limit. By way of the box sections of mounting hardware 460, the leveling jacks 420 may be mounted to the main beam 410 such that the mounting plate 440 of the leveling jack 420 is substantially perpendicular to the transverse direction of the vehicle 100.

In some aspects, extension portions 412 may be provided with a plurality of connecting points (not shown) so that the spread between the leveling jacks 420 may be adjustable, such as for clearance purposes (e.g., to avoid collision with other frame components) and/or to account for the balance and/or stability needs of different models of vehicles. These connecting points may take the form of through-holes, detents, ridges, and/or the like, and in any combination, so as to assist with the registering of a certain arrangements of the leveling jacks 420 regardless of the attachment means utilized. It may be appreciated that, though the mounting hardware 460 of FIGS. 6A-6C are primarily depicted being suitable for welding, any comparable fastening means (e.g., welding, crimping, bolting, brackets, riveting, and/or the like, without limit) may be used to secure the leveling jack 420 and/or mounting plate 440 to the main beam 410.

As above, in some aspects, the leveling jacks 420 are controlled manually (e.g., via jog buttons, control panels, switches and/or levers, touchscreen controls, and/or the like, without limit). In some aspects, the leveling jacks 420 may be controlled automatically (e.g., via a controller having a processor, memory, storage, and corresponding software and/or other instructions stored thereon). Automatic control of the leveling jacks 420 may occur in isolated events (e.g., commanded by a user when the vehicle is parked, commanded by a user if it is noticed that the vehicle has settled or shifted), and/or automatic control of the leveling jacks 420 may be ongoing (e.g., the controller is provided with and/or connected to sensors that continuously and/or periodically monitor the state and/or level of the vehicle to make adjustments to bring the vehicle into a level state within predefined thresholds).

The cross-truss 400 may further include a set of mounting plates 450 secured to the main beam 410, such that the mounting plates 450 are used to mount the cross-truss 400 to the frame rails 202 of the vehicle chassis 200. The mounting plates 450 may each be provided with a plurality of through-holes 452 that are arranged in a predetermined hole pattern 454. In some aspects, the predetermined hole pattern 454 matches that of the outrigger 210, such that the through holes 452 of the mounting plates 450 would line up with corresponding holes provided in the frame rails 202 for mounting the outrigger 210. In other words, the predetermined hole pattern 454 matches and/or is compatible with a pattern in which fasteners are arranged to mount the outrigger 210 to the frame rail 202 so that the cross-truss may be similarly mounted to the vehicle chassis 200 via fasteners (e.g., screws, bolts, and/or the like, without limit).

In some aspects, the predetermined hole pattern 454 precisely matches the outrigger pattern and/or matches the outrigger pattern within a predetermined tolerance. In some aspects, the hole pattern 454 only partially matches the outrigger pattern or approximates the outrigger pattern. In some aspects, one or more holes of the predetermined hole pattern may be elongated or oblong, such as to account for manufacturing tolerances, thermal expansion, different outrigger patterns (e.g., from different manufacturers, across different chassis models, and/or across different chassis revisions). In some aspects, the number of holes of the predetermined hole pattern 454 differs from the number of holes of the outrigger pattern. In some aspects, the mounting plates 450 may be permanently attached (e.g., via welding and/or the like, without limit) to the frame rails 202, instead of and/or in addition to the use of fasteners.

It is further contemplated that the mounting plates 450 may be oriented so as to connect to an outer face of the frame rails (as depicted) and/or to connect to any other face (e.g., top, bottom, inside), of the frame rails 202, and/or in any combination, as installation space and/or clearance needs dictate.

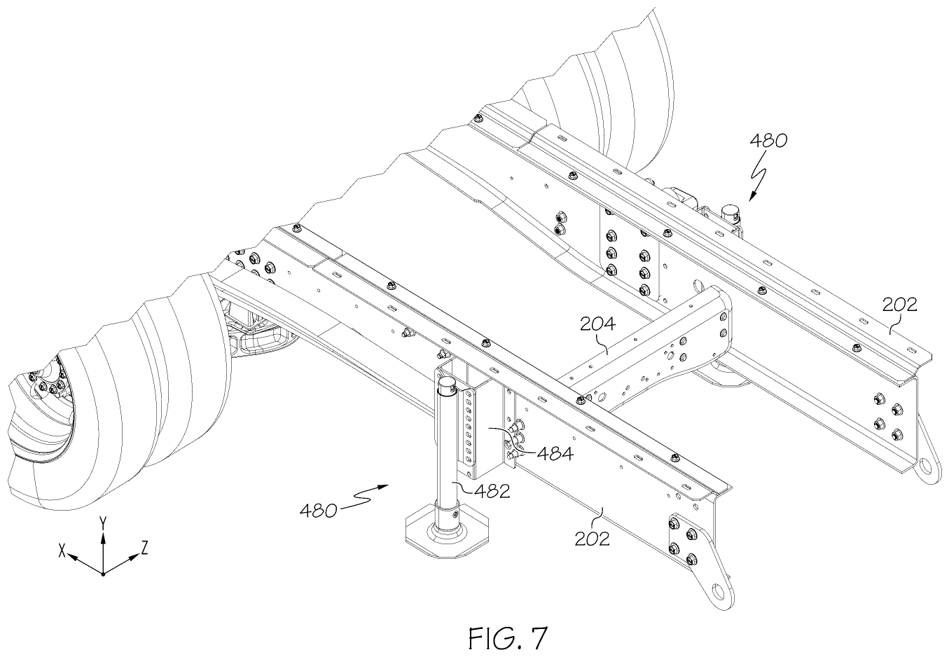

Turning now to FIG. 7, with continued reference to FIGS. 1 and 5-6C, and as above, a plurality of further leveling jacks 480 are shown arranged near a second end 201B of the vehicle chassis 200 and mounted to the frame rails 202 of the vehicle chassis 200 via. In some aspects, the actuator(s) 482 of the further leveling jacks 480 may be mounted to the frame rails 202 via a mounting bracket 484 (e.g., a C-channel or hat-channel bracket) so as to provide better access to mounting hardware for installation and/or removal.

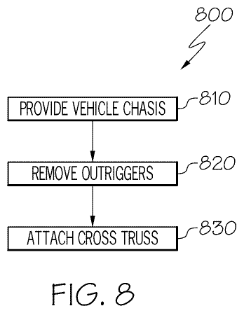

Turning now to FIG. 8, with continued reference to FIGS. 1-7, an illustrative method relevant to the installation of a cross-truss further to those disclosures herein is shown.

In step 810, a vehicle chassis 200 may be provided, such as an RV chassis or a truck chassis. The vehicle chassis 200 may be that of a vehicle that is currently being manufactured and/or that of a vehicle that is being repaired, retrofitted, and/or the like. As discussed above, such chassis typically are provided with multiple sets of outriggers 210, 220 joined to frame rails 202 in order to secure the cabin, seats, and/or the like to the vehicle chassis 200.

In step 820, one or more sets of outriggers 210, 220 are removed from the vehicle chassis 200 to make way for the cross-truss 300, 400. As above, the outriggers are typically secured to frame rails 202 of the vehicle chassis 200 by a plurality of fasteners arranged in an outrigger pattern.

In step 830, the cross-truss 300, 400 is secured to the vehicle frame 200, such as by fastening (e.g., nuts and bolts) or welding. As above, in some aspects, the one or more mounting plates 350, 450 of the cross-truss 300, 400 and corresponding hole patterns 354, 454 may line up with the outrigger pattern. In this way, the cross-truss 300, 400 may be mounted to the vehicle chassis 200 without requiring any substantial modifications, if any, of the vehicle chassis 200.

It should now be understood that aspects of the present disclosure are directed to a cross-truss system, a cross-truss, and/or a method for installing the same for the purposes of leveling and/or stabilizing a vehicle, such as an RV.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While several aspects have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the aspects described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific aspects described herein. It is, therefore, to be understood that the foregoing aspects are presented by way of example only and that, within the scope of the appended claims and equivalents thereto, aspects may be practiced otherwise than as specifically described and claimed. Aspects of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one aspect, to A only (optionally including elements other than B); in another aspect, to B only (optionally including elements other than A); in yet another aspect, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one aspect, to at least one, optionally including more than one, A, with no B present (and optionally including elements other than B); in another aspect, to at least one, optionally including more than one, B, with no A present (and optionally including elements other than A); in yet another aspect, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It is to be understood that the aspects are not limited in its application to the details of construction and the arrangement of components set forth in the description or illustrated in the drawings. The invention is capable of other aspects and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several aspects of the invention has been presented for purposes of illustration. It is not intended to be exhaustive or to limit the invention to the precise structure, steps, and/or forms disclosed, and obviously many modifications and variations are possible in light of the above teaching.

1. A cross-truss assembly for at least partially supporting a vehicle chassis, the assembly comprising:
the vehicle chassis, the vehicle chassis comprising:
a plurality of frame rails that extend along a longitudinal direction of the vehicle chassis and that are configured to mount a vehicle body, and
a plurality of lateral members that join the plurality of frame rails together;
a cross-truss arranged transverse to the plurality of frame rails, wherein:
the cross-truss is fastened to at least two of the plurality of frame rails;
the cross-truss comprises an extension portion at each end, each extension portion extending beyond a respective one of the plurality of frame rails; and
a leveling jack is mounted to each of the extension portions.

2. The cross-truss assembly of claim 1, wherein the cross-truss comprises a main beam, and the main beam is arranged above at least two of the plurality of frame rails.

3. The cross-truss assembly of claim 2, wherein the main beam extends beyond each of the leveling jacks.

4. The cross-truss assembly of claim 1, wherein the cross-truss comprises a main beam, and the main beam is arranged below at least two of the plurality of frame rails.

5. The cross-truss assembly of claim 1, wherein the cross-truss comprises a plurality of mounting plates, each configured to mount with the respective one of the plurality of frame rails.

6. The cross-truss assembly of claim 1, wherein each of the plurality of mounting plates comprises a plurality of through-holes.

7. The cross-truss assembly of claim 6, wherein the plurality of through-holes are arranged in a predetermined pattern.

8. The cross-truss assembly of claim 7, wherein the predetermined pattern matches an outrigger pattern used for securing an outrigger to one of the plurality of frame rails.

9. The cross-truss assembly of claim 1, wherein:
the cross-truss is arranged near a first end of the vehicle chassis;
the vehicle chassis further comprises a pair of further jacks arranged near a second end of the vehicle chassis; and
a spread of the pair of further jacks is narrower than a spread of the leveling jacks mounted to the extension portions of the cross-truss.

10. The cross-truss assembly of claim 1, wherein the cross-truss is arranged substantially in a transverse direction; each of the leveling jacks comprises a mounting plate; and the mounting plate is mounted substantially parallel to the transverse direction.

11. The cross-truss assembly of claim 1, wherein the cross-truss is arranged substantially in a transverse direction; each of the leveling jacks comprises a mounting plate; and the mounting plate is mounted substantially perpendicular to the transverse direction.

12. The cross-truss assembly of claim 1, wherein each of the leveling jacks is at least one of an electric and a hydraulic leveling jack.

13. A method for installing a cross-truss, the method comprising:
providing a vehicle chassis, the vehicle chassis comprising:
a plurality of frame rails that extend along a longitudinal direction of the vehicle chassis and that are configured to mount a vehicle body,
a plurality of lateral members that join the plurality of frame rails together, and
at least two outriggers, each of the at least two outriggers being secured to a respective one of the plurality of frame rails;
removing the at least two outriggers from the vehicle chassis; and
securing the cross-truss to the vehicle chassis.

14. The method of claim 13, wherein:
each of the at least two outriggers are secured to the respective one of the plurality of frame rails by a plurality of fasteners arranged in an outrigger pattern; and
the cross-truss comprises a plurality of mounting plates, each having a plurality of through-holes arranged in the outrigger pattern.

15. The method of claim 13, wherein:
the cross-truss comprises an extension portion at each end, each extension portion extending beyond a respective one of the plurality of frame rails; and
a leveling jack is mounted to each of the extension portions.

16. The method of claim 15, wherein a spread of the leveling jacks mounted to the extension portions of the cross-truss is greater than a spread of a pair of further jacks provided at an opposite end of the vehicle chassis.

17. The method of claim 13, wherein the cross-truss comprises a main beam, and the main beam is arranged above at least two of the plurality of frame rails once the cross-truss is secured to the vehicle chassis.

18. The method of claim 17, wherein the main beam extends beyond each of the leveling jacks.

19. The method of claim 13, wherein the cross-truss comprises a main beam, and the main beam is arranged below at least two of the plurality of frame rails once the cross-truss is secured to the vehicle chassis.

20. A cross-truss for mounting to a vehicle chassis, the cross-truss comprising:
a main beam that extends in a transverse direction and that includes an extension portion at each end;
a leveling jack mounted to each of the extension portions; and
a plurality of mounting plates for mounting the cross-truss to the vehicle chassis, each of the plurality of mounting plates comprising a plurality of through-holes arranged in a predetermined pattern that matches an outrigger pattern used for securing an outrigger to the vehicle chassis.
